(19) United States
(12) Patent Application Publication
(10) Pub. No.: US 2006/0005976 A1
(43) Pub. Date: Jan. 12, 2006

(54) Grass plantlet harvester

(76) Inventors: Henry Decker, Ostrander, OH (US); Greg Ekstam, Greenville, KY (US)

Correspondence Address: Isaac A. Angres, Suite 310, 2001 Jefferson Davis Highway, Arlington, VA, 22202, US

(21) Appl. No.: 11/177,399

(22) Filed: Jul. 11, 2005

Related U.S. Application Data
(60) Provisional application No. 60/587,287, filed on Jul. 12, 2004.

(51) Int. Cl. A01B 45/04

(52) U.S. Cl. 172/19

(57) ABSTRACT

The invention provides an apparatus for effectively harvesting juvenile grass sods comprising: (a) a sod cutting mechanism followed by a conveyer which lifts and carries the cut sod up to a box or housing containing at least one rotating cylinder or roller; (b) rotating cylinder(s) or roller(s) having attached bars into which are placed steel pins of various lengths, diameters, and shapes; (c) a steel pin cylinder(s) or roller(s) that separates the sod into vegetative material and growing medium and extracts from the vegetative fraction complete grass plantlets that drop onto one or more secondary conveyers; and (d) secondary conveyer(s) that removes any remaining growing medium and moves the grass plantlets to the rear or side trailing collection wagons for any subsequent processing and bagging.

This application claims the priority benefit under 35 U.S.C. section 119 of U.S. Provisional Patent Application No. 60/587,287 entitled “Grass Plantlet Harvester”, filed Jul. 12, 2004, which is in its entirety herein incorporated by reference.

### TECHNICAL FIELD OF THE INVENTION

This invention deals with the harvesting of a newly discovered type of vegetative propagating material, namely Grass Plantlets, with new cultivar replication, and with sod production particularly in grasses. More in particular, the instant invention relates to an apparatus for harvesting grass plantlets.

### RELATED PATENTS

This invention is related to several new discoveries detailed in U.S. patent application Ser. No. 10/745,516 that extends earlier research embodied in U.S. Pat. No. 5,899,020 (1999), entitled “Method for the Vegetative Propagation of Grasses”, and U.S. Pat. No. 5,899,020 (1999), entitled “Liquid Mulch Method and Apparatus for Manufacturing Sod”.

Other related patents which form a basis for this new invention include innovations in which sod is grown over plastic sheeting as described in U.S. Pat. Nos. 4,986,026; 5,177,898; and 5,481,827.

A comprehensive review of this genre entitled “Producing Sods over Plastic in Soilless Media” by H. F. Decker appears in the 2001 annual Horticultural Review Volume 27: pp 317-351.

### BACKGROUND OF INVENTION

In earlier experiments, vegetative propagation was studied on a field scale in southern warm season turfgrasses particularly bermudagrass. Many warm season grasses are sterile hybrids and do not set enough seed to be progpagated by seed commercially. Hence, many of these grasses are reproduced vegetatively by “sprigging” which is material harvested from verticuttiing mature fields of sod or from shredding bulk sod of the grass; or by “plugging”, typically three inch square pieces of grass sod, into soil.

A new method of propagating warm season grasses other than by “sprigging” or “plugging” was described in U.S. Pat. Nos. 5,806,445 and 5,899,020. In this new system sod of the cultivar to be propagated, typically over plastic sheeting, is separated into small, complete pieces which I refer to as Grass Plantlets (or simply GPs) which are described in the earlier patent application Ser. No. 10/745,516. While Grass Plantlets can be harvested by this invention from sods grown directly on soil, it is preferable to produce the sod over plastic sheeting so that a cleaner product can be obtained by reducing contamination from deleterious soil-borne organisms and where it is desirable to maintain the integrity of the primary rooting system. Sods grown over plastic can also be harvested much earlier than sods grown directly on soil as indicated in several of our earlier patents listed above.

More recently, in research supported by a grant from the USDA, the studies were broadened to examine the potential for the field scale vegetative propagation of northern cool season grasses such as bentgrass and bluegrass. These cool season turfgrasses tend to be prolific seed producers and hence are commercially propagated from seed rather than vegetatively. Nevertheless, several of these grasses, notably bentgrass can spread vegetatively with impressive vigor . . . often as quickly, it was discovered, as some of the warm season bermudagrasses.

Vegetative propagation was explored more fully in several cool season grasses to determine if there were any advantages in propagating these seeded grasses vegetatively. It was discovered in these studies that many cool and warm season turfgrass cultivars can be produced, propagated, and increased more rapidly by using Grass Plantlets than by seed, sprigs, or plugs. For example the Grass Plantlets recovered from one square foot of a bentgrass sod grown over plastic sheeting is subsequently sufficient to produce as much as 50 square feet of new sod in 8-10 weeks.

### BRIEF DESCRIPTION OF THE FIGURES

FIG. 1 is a schematic view of the Grass Plantlet Harvester of the invention.

FIG. 2 is an enlarged end view of a steel pin roller used in the Grass Plantlet Harvester shown in FIG. 1.

### SUMMARY OF THE INVENTION

The instant invention provides an apparatus for effectively harvesting juvenile grass sods said apparatus comprising: (a) a sod cutting mechanism followed by a conveyer which lifts and carries the cut sod up to a box or housing containing at least one rotating cylinder or roller; (b) said rotating cylinder(s) or roller(s) having attached bars into which are placed steel pins of various lengths, diameters, and shapes; (c) a steel pin cylinder(s) or roller(s) that separates the sod into vegetative material and growing medium and extracts from the vegetative fraction complete grass plantlets that drop onto one or more secondary conveyers; and (d) secondary conveyer(s) that removes any remaining growing medium and moves the grass plantlets to the rear or side trailing collection wagons for any subsequent processing and bagging.

The invention is also directed to a means and a mechanism for replicating and increasing both warm and cool season grass cultivars more quickly and in larger quantities by using Grass Plantlets rather than by the conventional methods of increasing seed stock, sprigs, or plugs.

It was also discovered that it was possible to grow sods and harvest Grass Plantlets from both warm and cool season grasses often in ten weeks or less which is quicker than growing the sods from seed. The amount of Grass Plantlets required to produce a warm season Bermuda grass and a cool season bent grass was about the same.

It was also discovered that a planting of Grass Plantlets of the same cultivar establishes more quickly than by “sprigging” and much more quickly than by “plugging”. This was because the Grass Plantlets are small pieces that are positioned so that they are evenly spread out without overlap and hence exposed to unobstructed sunlight. This in turn increases the speed with which the cultivar spreads or closes.

Growing sods over plastic sheeting in sterile growing media also make it possible to protect the growing sod from nematodes and other deleterious organisms including pathogenic micro-organisms.

Furthermore, since the GPs are replicated asexually, genetic purity can be maintained in grasses where it is not fixed by apomixis; or in crosses where it is possible to fix heterosis with apomixis. The system can also rapidly expand the availability on a field scale of planting materials of direct but sterile DNA transfers.

To effect this innovative growing system a machine was invented that harvests Grass Plantlets directly in the field by feeding the cut sod of a selected cultivar over a specially designed cylinder onto which pin bars can be readily attached. Placed on the bars at set intervals are various sizes and shapes of steel pins which separate the vegetative material from the growing medium. The pin system is much less damaging to the vegetative and meristematic tissues of the grass than in our earlier separation methods of milling or shredding the sod as reported in U.S. Pat. No. 5,899,020. This is a significant improvement in the harvesting of vegetative planting material. Yields of intact and complete Grass Plantlets are tenfold greater than in the older systems and hence will plant more new acreage per acre of harvested Grass Plantlets.

### DESCRIPTION OF THE INVENTION

The present invention provides an effective sod harvesting apparatus that is able to harvest intact Grass Plantlets on a field scale from sod, typically grown over plastic sheeting, of a selected cultivar by cutting and lifting the sod and conveying and feeding the sod over a cylinder to which carefully sized and shaped hard pins are attached. This system separates the sod with much less damage to vegetative and meristematic tissue (the crown) yielding a significantly higher number of Grass Plantlets per area harvested than by hammer mills or shredders proposed in our earlier patents.

The harvested separated grass plantlets continue to travel over a subsequent, mat chain, open conveyor which vibrates off any remaining growing medium (which is returned to the soil or to the plastic to be used again for a subsequent crop). The clean Grass Plantlets are conveyed into a trailing wagon for further off-field processing.

This Grass Plantlet harvester produces small but active one/half to three inch, grass plantlets complete with crown, roots and shoots which when spread very evenly over a growing surface at the rate of 50-100 plantlets per square foot exposes them to greater amounts of unobstructed sunlight. This extra exposure of many smaller pieces per square foot speeds the spreading process and hence sod formation when compared to seeding, sprigging, and especially to plugging.

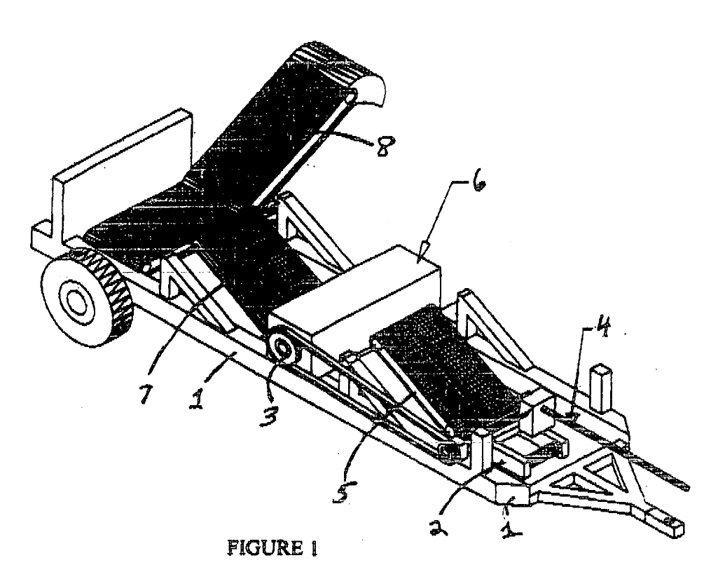

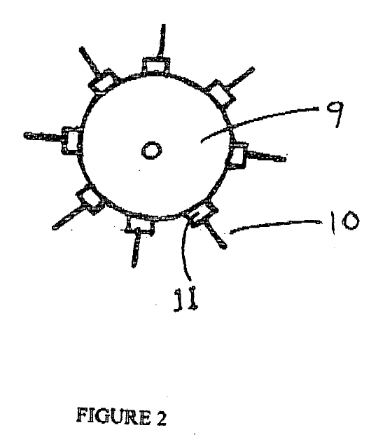

Referring to FIG. 1, it shows a schematic of the Grass Plantlet Harvester consisting of a tractor pulled single axle trailer (1) comprising a sod cutter (2) mat chain conveyers, and pin roller mechanism powered by axles and pulleys (3) attached to the tractor's PTO shaft (4). The sod is moved by the first mat chain conveyer (5) up and into the separation box or cylinder (6) which houses the pin roller mechanism as shown in FIG. 2. As the Grass Plantlets are separated by the pin roller from the growing medium of the sod they drop onto a second mat chain conveyer (7) which delivers the separated Grass Plantlets to a trailing collection wagon or, by inserting side conveyers (8) at a right angle to the center axis of the trailer, are off loaded to a side traveling collection wagon. The growing medium is shaken from the Grass Plantlets by the mat chain conveyers and falls through the conveyers to the growing surface where is used again for subsequent crops.

FIG. 2 is an enlarged end view of a steel pin roller (9) housed in the separation box or cylinder (6) of FIG. 1. The roller is comprised of various numbers, sizes and arrangements of steel pins (10) which are attached either directly to the roller or to pin bars (11) which in turn are attached to the roller. The diameter of the roller, the size, number and arrangement of the pins on the roller are specific to each grass cultivar being harvested for Grass Plantlets.

The size, shape, and number of steel pins of various lengths are positioned on the cylinder and are specific to each grass cultivar. The pins are placed in line on bars that are the length of the cylinder. The bars can be easily attached or detached and changed. Most pins are straight pins ⅜th to ¼th inch in diameter and 1 to 2.5 inches long which basically comb the sod for grass plantlets. Two other types of pins have also been considered: gently curved pins, 1 to 2 inches long tapering to curved ends, which pluck apart more woody types of grasses; and cutting pins which are 1 to 2.5 inches long, triangular in cross section, with the forward surface having a sharp edge to cut woody stolons and rhizomes into grass plantlet segments.

The effectiveness and aggressiveness of the pin roller(s) or cylinder and hence the degree of Grass Plantlet separation and removal of the growing medium can be controlled by several means:
a) the type and number of pins on a bar
b) the number of bars on a cylinder
c) the rotating speed of the cylinder
d) the ground speed of the harvester
e) the sod feeding speed of the conveyor
f) the angle at which the sod meets the pin bars
g) the angle and opening of the feeder plate
h) the clearance between rotating and stationary components

The ideal degree of separation from a given area of harvested sod yields 85 to 100% complete Grass Plantlets which are typically ½ to 3 inches long consisting of a single crown with shoot, roots, and leaves.

Subsequent experiments have indicated that metallic clothe cylinders in various configurations can also be used to accomplish Grass Plantlet separations comparable to those described above by using various pin rollers.

There are three other very important advantages to this new harvesting system for producing vegetative propagating material: (1) As the sod is harvested, the growing medium is shaken loose from the sod and returned to the planting surface to be used again for subsequent crops; (2) The sod is processed into Grass Plantlets which can be bagged right in the field as the machine is moving; and (3) The sod is harvested without cutting the plastic which can be used over again for subsequent crops.

Although the present invention has been described with reference to specific details of certain embodiments thereof, it is not intended that such detail should be regarded as limitations upon the scope of the invention, except as and to the extent that they are included in the accompanying claims.

What is claimed is:

1. An apparatus for effectively harvesting juvenile grass sods said apparatus comprising:
(a) a sod cutting mechanism followed by a conveyer which lifts and carries the cut sod up to a box or housing containing at least one rotating cylinder or roller;
(b) said rotating cylinder(s) or roller(s) having attached bars into which are placed steel pins of various lengths, diameters, and shapes;
(c) a steel pin cylinder(s) or roller(s) that separates the sod into vegetative material and growing medium and extracts from the vegetative fraction complete grass plantlets that drop onto one or more secondary conveyers; and
(d) secondary conveyer(s) that removes any remaining growing medium and moves the grass plantlets to the rear or side trailing collection wagons for any subsequent processing and bagging.

2. The apparatus according to claim 1, wherein bars with various types of steel pin lengths, shapes, and sizes are arranged on a cylinder or roller to effect a high yield of intact grass plantlets from specific grass cultivars.

3. The apparatus according to claim 2, wherein the steel pins may de straight and pointed, curved, or triangular shaped pins that are sharpened on the leading edge.

4. The apparatus according to claim 2, wherein the diameter of the roller or cylinder and the length of the pins can be combined to effectively yield intact and complete grass plantlets from specific grass cultivars.

5. The apparatus according to claim 1, wherein the number of pins on a bar and the number of bars on a cylinder or roller are combined to effectively yield intact and complete grass plantlets from specific grass cultivars.

6. The apparatus according to claim 1, wherein the rotating speed of the cylinder and the ground speed of the harvester are combined to effectively yield intact and complete grass plantlets from specific grass cultivars.

7. The apparatus according to claim 1, wherein the sod feeding speed of the conveyer and the angle in which the sod meets the rotating bars and pins are combined to effectively yield intact and complete grass plantlets from specific grass cultivars.

8. The apparatus according to claim 1, wherein the angle and the opening of the feeder plate are arranged to effectively yield intact and complete grass plantlets from specific grass cultivars

9. The apparatus according to claim 1, wherein the clearance between the rotating and stationary components of the box or housing can be arranged to effectively yield intact and complete grass plantlets from specific grass cultivars.

10. The apparatus according to claim 1, wherein the growing medium is returned to the growing surface to be used again for subsequent crops

11. The apparatus according to claim 1, wherein a sufficient quantity of grass plantlets are returned with the growing medium to the growing surface to establish a new crop.

12. A method for harvesting juvenile sod six to sixteen weeks old, complete grass plantlets each with an intact crown and one or more roots, shoots, and leaves which method comprises using the apparatus of claim 1.
